(19) United States
(12) Patent Application Publication
(10) Pub. No.: US 2015/0235319 A1
(43) Pub. Date: Aug. 20, 2015

(54) METHOD FOR SELECTING EQUITY INVESTMENTS USING QUANTITATIVE MULTI-FACTOR MODELS OF THE RELATIONSHIP BETWEEN COMMON BUSINESS CHARACTERISTICS AND CURRENT STOCK PRICES

(71) Applicant: Nathan A. Tidd, New York, NY (US)

(72) Inventor: Nathan A. Tidd, New York, NY (US)

(21) Appl. No.: 14/621,462

(22) Filed: Feb. 13, 2015

Related U.S. Application Data
(60) Provisional application No. 61/940,030, filed on Feb. 14, 2014.

(51) Int. Cl. G06Q 40/06

(52) U.S. Cl. CPC G06Q 40/06

(57) ABSTRACT

The present invention provides a novel method for evaluating investment instruments using an objective actor based methodology for assessing such factors independent contribution to profits which includes the steps of: supplying, for the plurality of said businesses, datasets of historical reported corporate profits and datasets of said historical business characteristics (factors) correlated to said corporate profits; calculating, for each of said factors and for each historical period in the dataset, a weighting value for each of said businesses representing the relationship between the business and the factor; for each historical period in the dataset, applying a regression analysis to the plurality of weighting values for the plurality of factors and the reported profits for the plurality of businesses to determine the reported profits attributable to each of said factors; and calculating a profit forecast for each of said factors.

### CROSS-REFERENCE TO RELATED APPLICATIONS

This application claims priority to U.S. Patent Application Ser. No. 61/940,030 (filed Feb. 14, 2014) the entirety of which is incorporated herein by reference.

### FIELD OF THE INVENTION

The present invention is related to the field of equity investment management, more specifically the task of analyzing a firm and its associated equity security in order to inform the investor's decision to purchase, continue holding, or sell the security.

### BACKGROUND OF THE INVENTION

Equity investment managers pursuing active strategies seek to construct portfolios of investments that produce above-average returns for investors (individuals, pension funds, or other capital providers). Their goal differs from equity managers pursuing passive strategies, who seek to construct a portfolio that produces average returns at a low cost, often by tracking a market index.

To achieve their goal, active managers employ proprietary investment processes comprised of different systems and methods of identifying attractive equity investments and combining them into a portfolio. These equity analysis methods fall into two categories: valuation methods and returns methods. Managers using valuation methods are primarily concerned with assessing the intrinsic value of an investment as compared to its current price. Managers using returns methods are primarily concerned with assessing the expected returns of an investment as compared to the market risk of those returns. The two types of methods employ markedly different systems to produce distinct information about an investment that the manager uses to select the most attractive securities.

An illustration of the hierarchy of analysis methods is provided in FIG. 1. Examples of pre-existing valuation methods include the Discounted Cash Flow (DCF) Method and the Valuation Comparison (VC) Method. Examples of pre-existing returns methods include the Technical Analysis (TA) Method and the Returns Factor (RF) Method. The present invention, referred to herein as the Valuation Factor (VF) Method, adapts systems developed for the Returns Factor Method within the price-to-value framework used by valuation methods.

The pre-existing valuation methods generally accepted as the most theoretically sound, which date at least to the 1930s [Graham & Dodd, 1934], define an equity investment's intrinsic value to be the present value of the future cash flows to which the holder of the investment is entitled. A widely used method of this type is the Discounted Cash Flow (DCF) Method as described in Valuation: Measuring and Managing the Value of Companies (McKinsey & Co, 2010). In this method, the manager first processes all available information about a company, including but not limited to macroeconomic and industry-specific growth forecasts, interviews with company personnel and industry experts, and company-specific information such as financial reports and corporate announcements. Next the manager estimates how much current profits will grow in the future based on said information, and also calculates a discount rate to reduce the value of those profits based on their expected timing and risks. Finally, the manager compares the sum of the discounted profits with the current market price of the security to determine if the investment is over- or under-valued. Within the constraints of transaction costs, estimation error, and policies mandated by their sponsors, the manager buys or continues holding investments deemed to be undervalued and, if currently owned, sells investments deemed to be overvalued.

The DCF method has numerous well-known shortcomings. First, the process is so labor intensive that most investment professionals only have time to fully analyze a small fraction of the available investment opportunities. Also the resulting estimates of investment value become outdated, sometimes very quickly, as new information about the company becomes available. Further, the process requires the user to develop growth forecasts that are difficult to estimate accurately, particularly for periods far in the future, and also to calculate a discount rate from assumptions about aggregate equity prices that can become disconnected from prices observed in public equity markets. The subjectivity inherent to the process limits transparency, reducing the ability of managers to rely on analysis prepared by different individuals, or to compare different firms using the DCF method to determine which of a subset of securities presents the best investment opportunity. Finally, the method does not consider the extent to which the risks inherent to the investment are correlated with other investments in the portfolio.

As a partial solution to these issues, many practitioners employ a simpler yet theoretically similar method based on the broadly known stable perpetual growth model. The most common variant is the Valuation Comparison (VC) Method. Using this method a manager first calculates, for each investment in the universe of alternatives, the ratio between its current price to one or more measures of corporate earnings accruing to the investor, for example the firm's estimated net income for the coming year, reported net income for the prior year, and/or the average net income reported over multiple preceding years, as shown by Equation 1.

$$P / E = \frac{1}{r - g} = V \qquad Equation 1$$

In this equation P is the current investment price, E are the corporate earnings (cash flows), r is the discount rate, g is the growth rate, and V is the calculated valuation ratio used to gauge price levels. Note that where the DCF Method requires the manager to estimate r and g, the VC Method arrives at V, the inverse of the combined risk-adjusted growth rate (r-g), using only objectively observable inputs, thereby avoiding the subjectivity of the DCF Method.

Once the universe of valuation ratios is calculated, the manager uses them in two instances. First, the manager screens the universe of alternatives to identify those investments with the desired valuation range, thereby increasing the likelihood that the more labor intensive DCF Method will be conducted on a desirable investment. Second, the manager uses the VC Method to monitor assets on an ongoing basis to ensure there have been no significant changes to the security price or associated company profits since the DCF Method was last performed. Both the screening and monitoring processes are performed on a recurring basis to identify changes in investment opportunities that may reverse prior investment decisions.

While the VC Method serves to increase manager efficiency, it lacks the flexible granularity of the DCF Method. Managers therefore have difficulty interpreting changes over time, which may be driven by changes in market expectations for profit growth from an investment (g) or a change in the supply of capital driving the implied discount rate (r). Also, like the DCF Method the VC Method does not consider how the risks of the investment relate to others in the portfolio and further, it has limited comparability across investments since firms with very different risk-adjusted growth prospects may have similar valuation ratios.

To increase the insights possible with the VC Method, some managers also calculate the valuation ratio for portfolios of investments in firms with common characteristics such as primary industry, similar market capitalization (large, medium, small), or the level of firm profitability or sales growth, and compare the valuation ratio of an individual investment with those of said portfolios to determine the relative valuation of the investment. However doing so increases the subjectivity of the method, as the clarity of which each characteristic explains the valuation of an individual investment decreases as the number of characteristics considered increases. Few managers develop enough conviction about a firm's over- or under-valuation to make an investment decision based on P/E analysis alone.

FIG. 2 illustrates a simple analysis performed during the VC Method. In this example the P/E ratios of three large-capitalization technology stocks with low price-to-book value of equity (Value) are compared against each other and three index portfolios represented their distinct characteristics (Large Cap, Technology, and Value). While Hewlett-Packard is clearly less expensive than the other reflecting lower growth expectations, the example illustrates the difficult determining whether the higher valuation for Microsoft and Apple securities is determined by the technology sector, their Value classification, or something specific to the firm.

By contrast, the Technical Analysis (TA) Method considers only market data when selecting investments. This method, described in various texts such as The Evolution of Technical Analysis [Lo & Hasanhodzic, 2011] is primarily comprised of the steps of 1) acquiring historical price change (the principal component of equity returns) and trading volume information for each of a universe of investments using information supplied with broadly available datasets; 2) applying transformative formulas to produce moving averages, candlesticks, and up/down metrics; 3) comparing the current metrics for the universe of securities with those of historical periods for the same or similar securities; and 4) selecting securities whose metrics show similarities to securities that performed well following said similar historical periods. While the method is used by some investors, mostly short-term investors or traders, noted limitations such as the difficulty of systematically interpreting data and the reliance on history repeating itself have limited the acceptance of the TA Method in the broader investment community.

An alternative that offers certain advantages over both the TA Method and also, with some important tradeoffs, the VC Method is the Returns Factor (RF) Method based on modern portfolio theory (Markowitz, 1953) and further developed by Barr Rosenberg in the 1970s. The RF Method considers investment returns against market risks instead of valuations. The object of the RF Method is to identify attractive investment characteristics common to many securities. Such characteristics, or factors, are attractive if compared to alternatives they have proven to consistently increase in value over time and can be reasonably expected to increase in value in the future.

Notably more complicated to perform than the VC Method, the RF Method requires the acquisition, management, and transformation of large quantities of financial data through a series of Model Calculation Steps that precede a set of Analysis Steps analogous to those described for the other methods. The system used for the Model Calculation Steps, which shall also be used by the present invention, is illustrated in FIG. 3.

The method requires systems of computers to host multiple databases in a reliable, redundant, secure, and scalable environment. Portions of the systems can be either locally hosted or remotely. Internet connectivity is required if portions of the computer system are hosted remotely. In addition to relational databases, the system requires statistical tools capable of linear regression analysis. Finally, the method requires numerous datasets from readily available commercial sources. These datasets include company financial reports, analyst earnings estimates, industry classifications, and financial market data.

In the first Model Calculation Step, the required datasets are acquired from their respective commercial providers (e.g. FTP) and said datasets are stored in the system's Vendor database. In Step 2, the datasets from different providers are linked across firms and securities, with the resulting data loaded into the Normalized database. In Step 3, the data is subjected to quality assurance checks to ensure completeness and accuracy of the datasets, with errors detected on an exception basis or by cross-checking data in multiple datasets. The verified data is loaded into the Clean database. In Step 4, the system's statistical software is invoked to apply mathematical Model Calculations to the dataset in the Clean Data Storage and loads the resulting dataset into the Production Data Storage. In the final step, the system packages the production data into files and transmits them to the portfolio analysis software tools for use during the Analysis Steps.

The system's aforementioned Model Calculation step follows the description in the publicly available Barra US Equity Model Handbook (Grinold et al, 1997) and illustrated in FIG. 4. For the desired universe of securities, which might be all known equities worldwide or a subset defined by geographic area, sector or industry, or asset characteristics such as firm size, the system calculates the Estimation Universe, a subset of securities representative of the total universe for which sufficient data exists in the Clean Data Storage. Next, the system applies Return Formulas to calculate asset excess returns from price changes and reported dividend information.

Next, the system applies Industry and Country Allocations algorithms to transform third-party country and industry classification data into a defined set of countries and industries for the model. Said algorithms balance the granularity of the model with the breadth of coverage required by the statistical algorithms to ensure accurate calculations. Each asset receives a weighting of 1 to a single industry and a single country and 0 to all other industries and countries. If the model covers a single geographic market the system only applies industry allocations.

In the next step, the system applies Descriptor Formulas to represent stock attributes known to influence asset returns to produce descriptors. The system then applies Risk Index Formulas to combine said descriptors into a parsimonious set that most completely explains returns for the universe and historical period. The formulas for each risk index assign, for each asset in the universe, a (z-score) value typically between −3 and 3, which represents the asset's exposure to the index. A list of broadly used risk indexes with their corresponding descriptor formulas is provided in FIG. 5.

In the next step the system applies, for each historical period, Cross-sectional Weighted Regressions to attribute asset returns to factors, as given in Equation 2.

rₐ=ΣₖXₖrₖ+rₐₛ Equation 2:

In this formula, Xₖ are the Risk Source Loadings comprised of the risk indexes and industry and country allocations at the start of the period (i.e. the prior month) and rₐ are the excess returns for each firm during the period. The system applies least-squares linear cross-sectional regression available in the statistical tools to estimate rₖ coefficients for each factor such that the portion of asset returns that cannot be explained by any factor (rₐₛ) is minimized.

In the final step, the system applies Factor Risk Formulas and Specific Risk Formulas to the historical time series of factor and asset-specific returns datasets to calculate forecasts of future prices based on past outcomes. The factor risk formulas compute the range of predicted outcomes expressed in terms of standard deviation (volatility) and/or an average return. Factors calculated to have an average predicted return of zero with higher volatility are referred to as risk factors. Factors with a positive or negative average predicted return and lower volatility are referred to as alpha factors.

The system loads the dataset produced by the Model Calculation Steps for each estimation period into Production Data Storage. In the final step, the system performs the Data Packaging algorithm to produce a dataset compatible with the system's analysis tools. Said dataset is comprised of the elements listed in FIG. 6.

With the Model Calculation Steps completed, the manager proceeds to select investments using the following set of analysis steps. First is the Problem Preparation step. In this step, share and price information for the current portfolio of investments (or a cash amount to be invested, if there is no portfolio) are loaded into the analysis system containing the dataset illustrated in FIG. 6 produced by the Model Calculation Step. Next, the system's analysis tool calculates the current exposures of the portfolio to the factors in the model, where the industry factor exposures are calculated using the market value for each position and the allocation information supplied by the model and the remaining factor exposures are calculated using an average z-score. Next is the Problem Definition step. In this step, the manager defines a set of rules to specify, within the parameters of the inputs supported by the analysis tool, which factors are attractive (alpha factors) and which are unattractive (risk factors) and also any constraints to be considered. Next is the Portfolio Construction step. In this step, the system applies its optimization algorithm to select a portfolio of securities that conforms to the specified rules and constraints. The final step is the Trading Step. In this step, the system computes a trade list comprised of the buy and sell orders the manager must execute to transition from the current portfolio to the ideal portfolio and sends it to the trader for execution.

Shortcomings of the Returns Factor Method include the inability, given its weak consideration of the price-to-profits relationship, to inform decisions about the attractiveness of individual investments, only certain characteristics of those investments. Further, those characteristics believed to be consistently attractive (alpha factors) are small in number and broadly known across investors, which can lead to sudden losses in attractiveness (i.e. investments with characteristics believed to be attractive underperform their alternatives). The method further assumes past relationships between factors are predictive of future relationships, which leads to suboptimal investment decisions during periods of changing investor behavior. More specifically, for factors that are attractive during some periods but not during others, the method does not lend itself to distinguishing changes in factor attractiveness. Another shortcoming is that the method calculates industry factor exposures based on market capitalization, which does not reflect the differences in economic exposure across securities. Finally, the approach does not facilitate the isolation of attributes that have significant value to investors (investment levels, cost advantages) yet do not explain returns well enough to be captured by the statistical tools required by the method.

There are also shortcomings across multiple methods. A shortcoming of the VC Method, TA Method, and RF Method is that they all require price information about a security, which has limited value for determining whether to purchase privately held investments or those being offered to the public for the first time (IPOs).

### SUMMARY OF THE INVENTION

A summary of the objectives for the present invention which cannot be fully met by any existing method for selecting investments is supplied in FIG. 7.

The present invention uses the systems required by the Returns Factor Method shown in FIG. 3 with a novel quantitative modeling method resulting in a new type of valuation method referred to in this document as the Valuation Factor (VF) Method. Unlike all prior methods, the present invention satisfies all objectives listed in FIG. 7.

The Model Calculation step of the VF Method differs from that of the RF Method (illustrated in FIG. 4) in several ways. First, instead of seeking to explain asset returns, the goal of the method is to explain equity prices and, in a separate step, to explain corporate profits, both using a consistent set of business characteristics (factors) possessed by many firms. The manager then uses 1) the relationship between current prices and profits for each factor, and 2) the portion of equity prices that cannot be attributed to any factor, to construct a portfolio of attractive investments.

Instead of requiring the user to provide estimates of future earnings (g) and a risk-adjusted rate (r) to discount those earnings to the present as required by the DCF Method, the approach instead assumes firms with similar characteristics will have similar growth and bear similar risks to the point that the r and g should be the same for all current earnings generated from that characteristic. Unlike the VC Method, the present invention attributes the current risk-adjusted growth (r-g) of the investment to its contributing factors.

Instead of solving the formula shown in Equation 2, the new method seeks to use cross-sectional weighted regressions to solve a novel multi-factor adaptation of the stable perpetual growth model (from Equation 1) as shown in Equation 3.

P^{A}=V₁π₁^{A}+V₂π₂^{A}+ . . . +Vₙπₙ^{A}+MP^{A} Equation 3:

In this formula, A is a firm whose equity is being valued, 1−n are the factors, V are the valuation ratios (i.e. P/E multiples) for each source, π^{A} are the profits for firm A from each source, MP^{A} is the firm-specific market premium for firm A, and P⁴ is the equity market value for firm A.

The method allows for a flexible number and definition of factors, which may include the firm's primary industry, geographic focus, cost advantages, financing policies, and macroeconomic sensitivities, as well as market premiums for firm characteristics such as recent sales growth. Since the goal is to explain current prices and profits instead of returns, the factors defined by the new method differ from those listed in FIG. 5 and used by the RF Method. Some factors require different datasets from commercial providers or use different elements within those datasets, and most if not all of the Descriptor Formulas in any embodiment will differ.

The novel dataset produced by the method's model building steps and distributed to analysis tools facilitates the selection of investments based on previously unavailable investment information, as illustrated in FIG. 14, which improves selection for individual investments, baskets of investments, or managers of portfolios of investments, and facilitates private investment selection without the manually intensive and subjective DCF Method.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1: Hierarchy of Equity Analysis Methods

FIG. 2: Example Valuation Comparison Analysis

FIG. 3: Modeling System for Returns Factor Method

FIG. 4: Returns Factor Modeling Method

FIG. 5: Typical Returns Factor Descriptors

FIG. 6: Returns Factor Model Output Dataset

FIG. 7: Summary of Objectives for the Present Invention

FIG. 8: Profit Model Estimation Flowchart

FIG. 9: Candidate Profit Descriptors

FIG. 10: Example Profit Source Loadings

FIG. 11: Profit Source Regression Formula

FIG. 12: Valuation Model Estimation Flowchart

FIG. 13: Valuation Model Regression Formula

FIG. 14: List of Novel Data Calculated by Valuation Factor Method

FIG. 15: Specification for First Embodiment (US)

FIG. 16: Industry Definitions for 1^{st} US Embodiment

FIG. 17: Business Factors for First US Embodiment

FIG. 18: Average Factor Profitability from First US Embodiment

FIG. 19: Selected Industry Factor Valuations from 1^{st} Embodiment

FIG. 20: Selected Business Factor Valuations from First Embodiment

FIG. 21: Selected Historical Firm-specific Premiums from 1st Embodiment

FIG. 22: 1st Embodiment Price Contributions for Selected Assets

FIG. 23: Selected Factor Valuations from First Embodiment

FIG. 24: Diagram of Stock Selection Steps

FIG. 25: Example Factor Screen Using First Embodiment

FIG. 26: Example Firm-specific Premium Screen Using First Embodiment

FIG. 27: Investment Monitoring Example: NETFLIX, INC

FIG. 28: Portfolio Weights in Select Business Factors

FIG. 29: Portfolio Industry Weights Comparison

FIG. 30: Example Investment Comparison from 1^{st} US Embodiment

FIG. 31: Basket Selection Steps

FIG. 32: Example Alpha Design Analysis from 1^{st} US Embodiment

FIG. 33: Manager Selection Steps

FIG. 34: Example Private Investment Analysis from 1^{st} US Embodiment

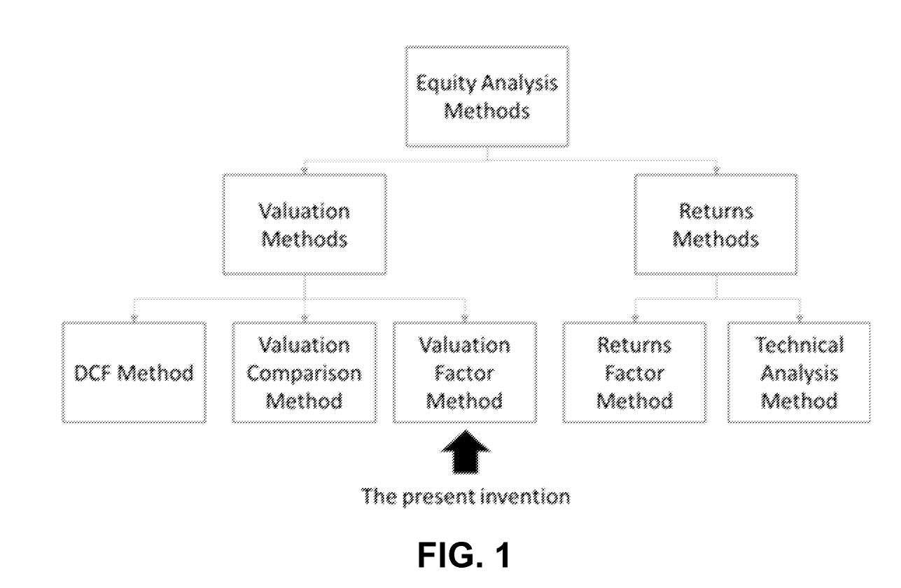

### DETAILED DESCRIPTION OF THE INVENTION

The present invention is comprised of a system to apply mathematical transformations on commonly available datasets in order to produce novel derived data useful for selecting investments and a method for using said derived data for the purpose of selecting equity investments.

The Process of Making the Invention

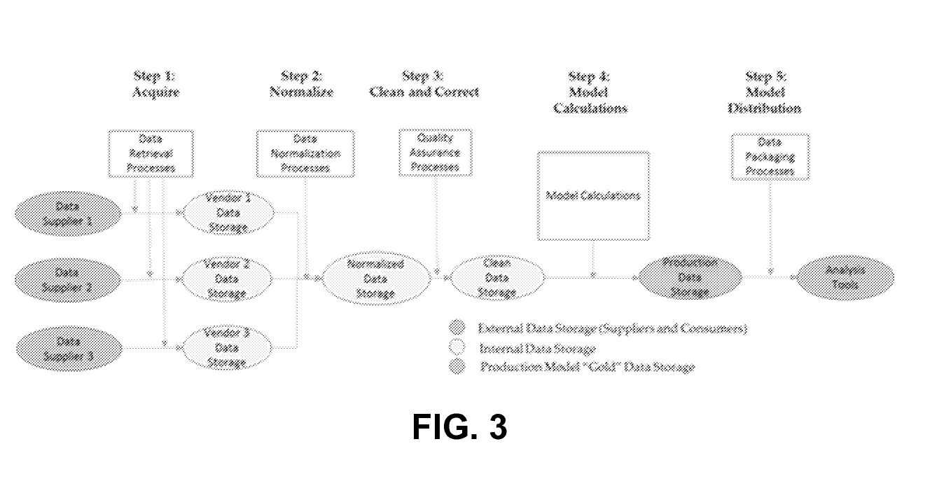

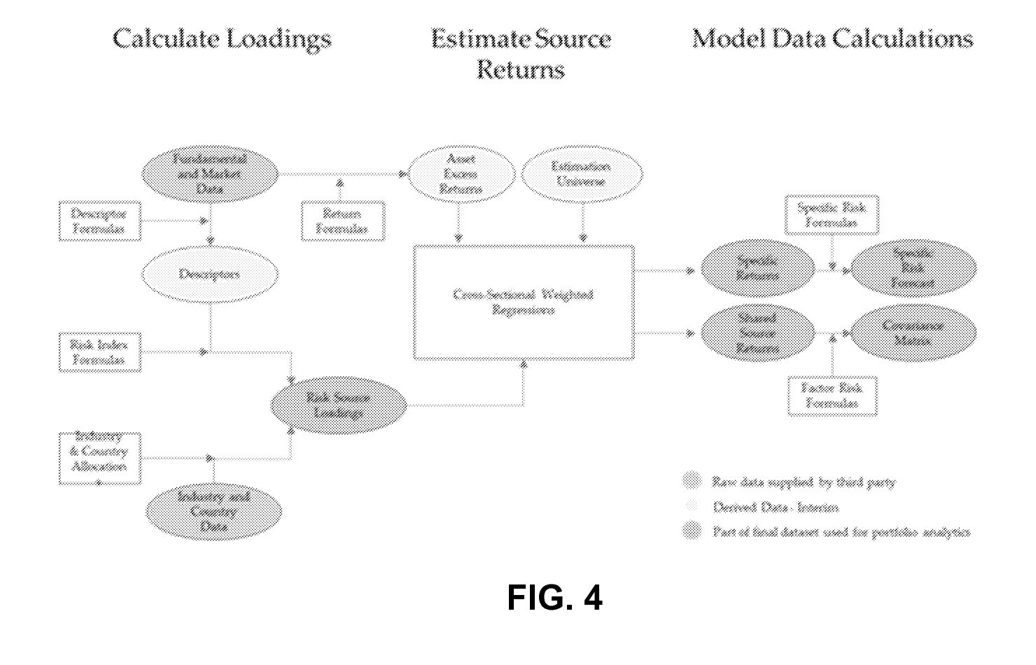

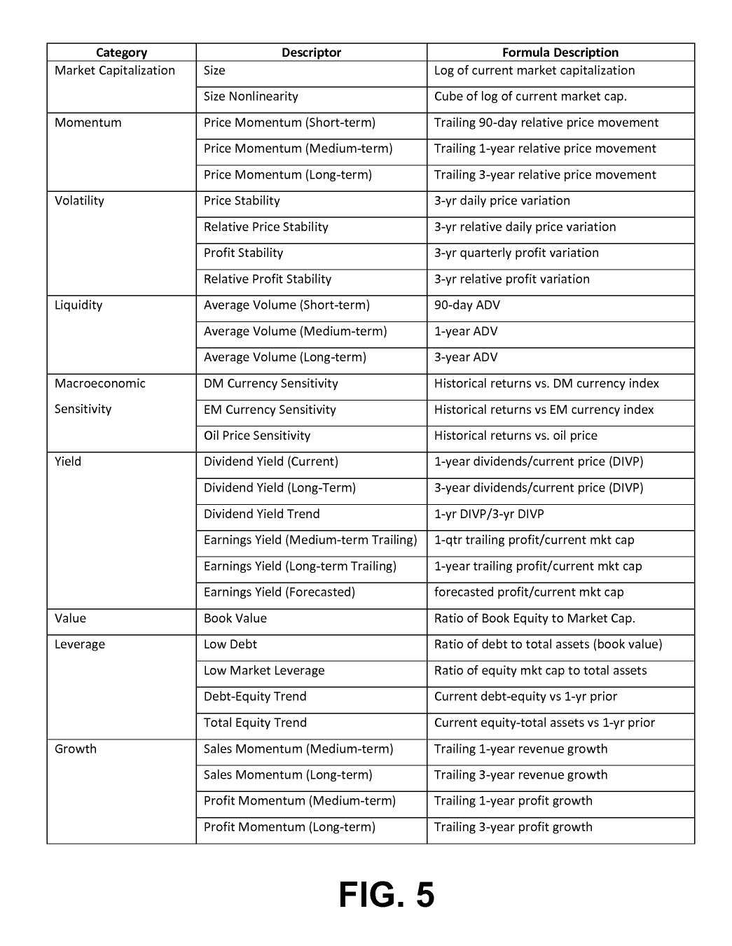

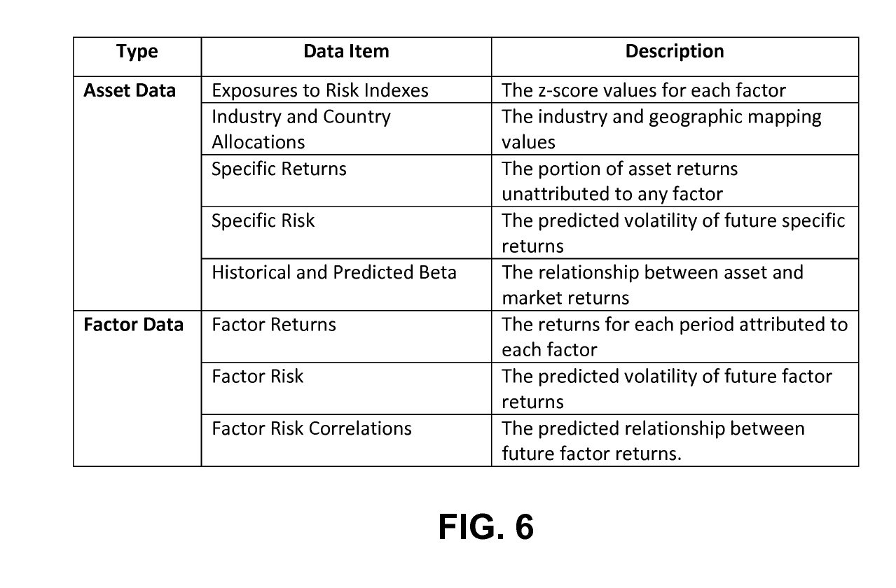

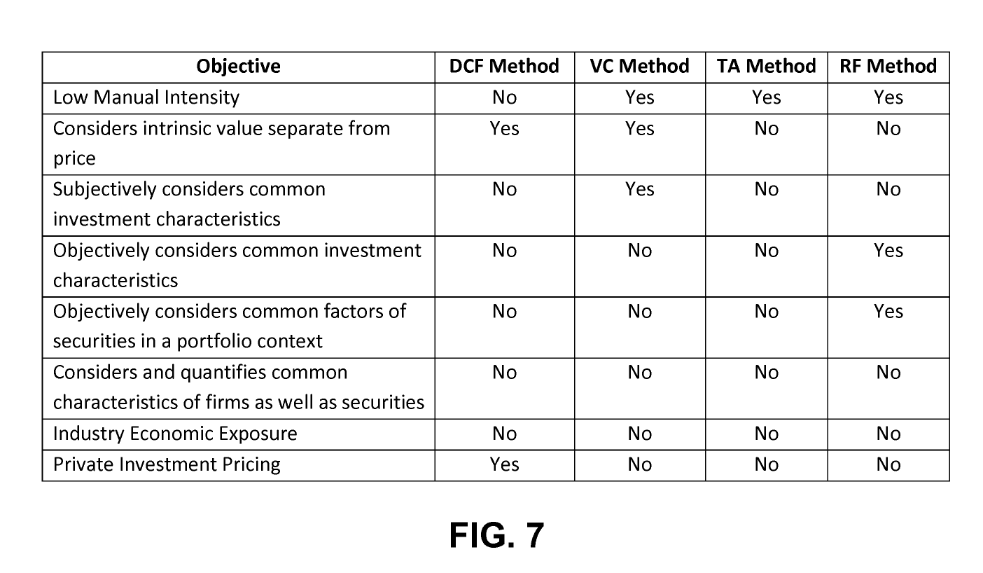

Prior to the present invention's novel Model Calculation step, the system acquires the required Input Datasets and performs the loading, normalization and verification steps used for Returns Factor Models as shown in FIG. 3. The three essential datasets are 1) corporate financial statement data, 2) industry and geographic classification data, and 3) equity securities market information. Additional datasets such as macroeconomic datasets or analyst estimates datasets may be required depending on the specific embodiment of the method.

The system performs the following Model Calculation steps for each desired estimation date for which sufficient data is available in Clean Data Storage.

In the first Model Calculation step, the system calculates the Estimation Universe for the desired Investment Category comprised of a representative list of investments with sufficient data availability.

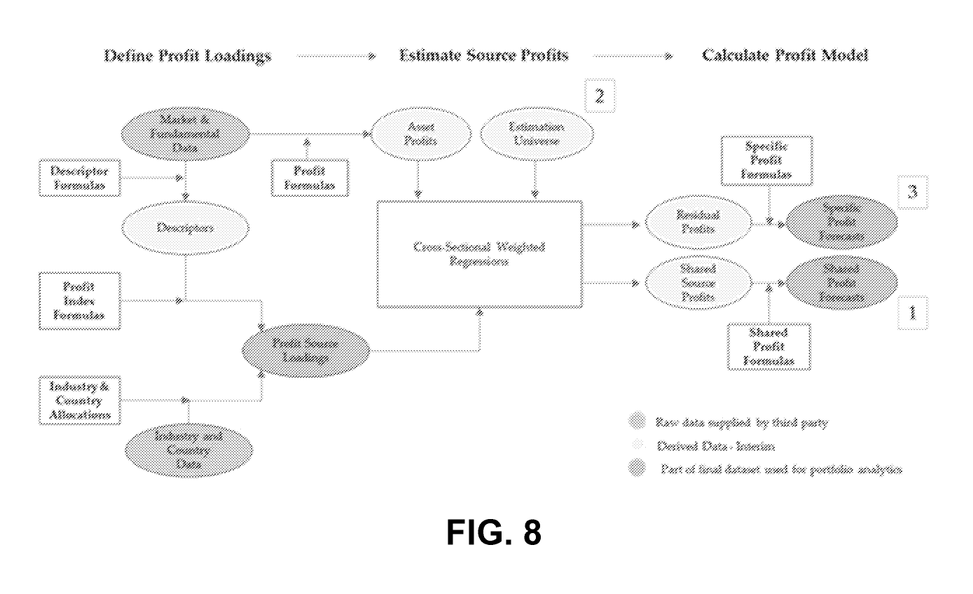

In the next several steps, the system performs mathematical transformations to attribute corporate profits to a set of common factors as illustrated in FIG. 8. In the first of said steps, the system applies Profit Formulas to the input data for each security in the universe of investments using the desired base profit definition, adjustments, forecast horizon, and normalization factor from the available datasets and computes Asset Profits using Equation 4.

$$\frac{{Σ}_{H} ( Profits - Adjustments )}{NF} \qquad Equation 4$$

In this formula, Profits is the base profit definition (operating income, EBITDA, cash from operations, or net income in its various reported forms); Adjustments are any unusual or extraordinary items removed from the base definition; H is the forecast horizon from the start date, in financial reporting periods (typically quarters); and NF is the normalization factor to account for differences in firm size, which may derive from any measure of the firm's economic activity: market capitalization, book value of assets, historical sales turnover, gross margin, or some weighted average of the aforementioned components.

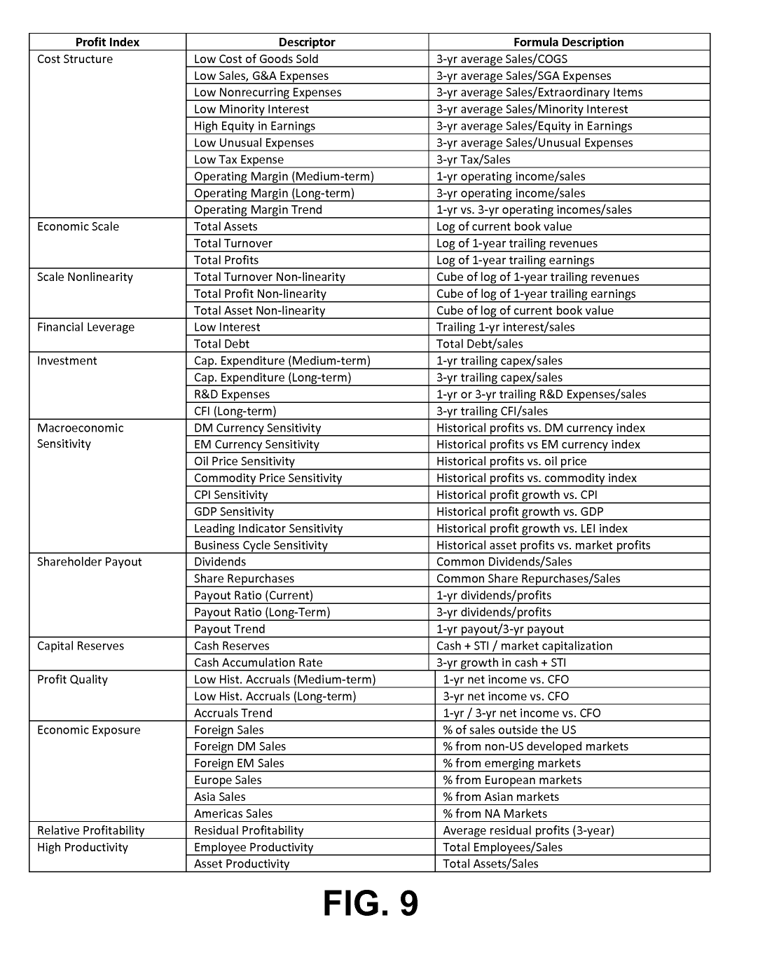

In the next step, the system applies Descriptor Formulas to describe attributes determined to explain corporate profits using the input data for each security in the universe of investments. A list of typical descriptors with their corresponding formula descriptions is shown in FIG. 9. Said descriptor formulas may require elements of input datasets such as asset fundamentals, market information, macroeconomic sensitivities, or combinations of said data items. Contrasting the descriptors defined by the RF Method, profit descriptors do not include price or returns data as an input and are more likely to include elements of a firm's income statement.

The next step is to apply Profit Index Formulas. In this step, the system applies mathematical transformations to the Profit Descriptors calculated in the preceding step to produce Profit Loadings useable by the Cross-sectional Weighted Regressions. These transformations include multicollinearity adjustments, outlier adjustments, and finally standardization. Multicollinearity adjustments combine multiple descriptors shown to behave similarly. Outlier adjustments such as truncation or winsorizing replace extreme descriptor values. Standardization ranks the values for each descriptor into an index.

The next step is to apply Industry and Geographic Allocations. In this step, the system transforms the industry and country data items from the input datasets into a dataset usable by the Cross-sectional Weighted Regressions step. To perform this step, the system assigns each firm to one or more industry factors, and potentially also to one or more geographic factors, based on the industry and geographic classification data from the input dataset. For input definitions with low representation in the estimation universe, the system combines multiple input definitions into a single model allocation to ensure each of said model allocations is represented by a minimum number of firms.

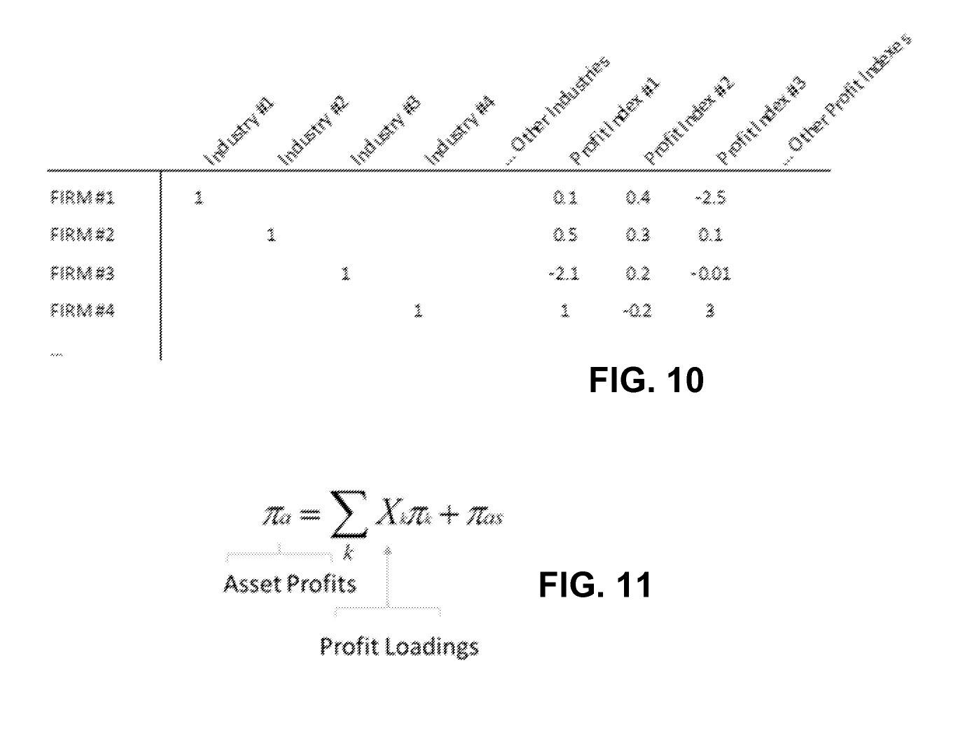

The Profit Source Loadings are the combination of the datasets produced by the Industry and Geographic Allocations step and the Profit Index Formulas step, an n-by-m matrix of values describing each firm in the universe using the indices for the defined factors, as illustrated in FIG. 10.

The next step is to apply Cross-sectional Weighted Regressions. In this step, the system's statistical software applies a linear least-squares regression algorithm to the profit loadings and asset profits to estimate the profit coefficients as shown by the equation in FIG. 11.

In this formula, the asset profits and profit loadings are calculated by the preceding steps. The coefficients (noted as πₖ) for each profit factor are calculated during the regression so that the residual profits for each firm (noted as πₐₛ) are as small as possible. The system weights the regression algorithm to place more importance on firms for which the data is known to be more reliable (e.g. larger firms).

The next step is to apply Profit Forecast Formulas. In this step, the system applies algorithms for combining the factor coefficients and firm-specific data from the cross-sectional weighted regressions step in different estimation periods into forecasts of future factor and firm-specific data. Said forecast algorithms include: a simple average of prior results; an average of historical periods with similarities to the current period; a weighted average of all periods giving higher importance to historical periods similar to the current period; and standard volatility calculations of the variation of any of said forecast algorithms. Said similarities include recent macroeconomic growth reported by government agencies or aggregate growth in corporate profits estimated by a pool of analysts, or simply favoring more recent periods (e.g. the half-life method).

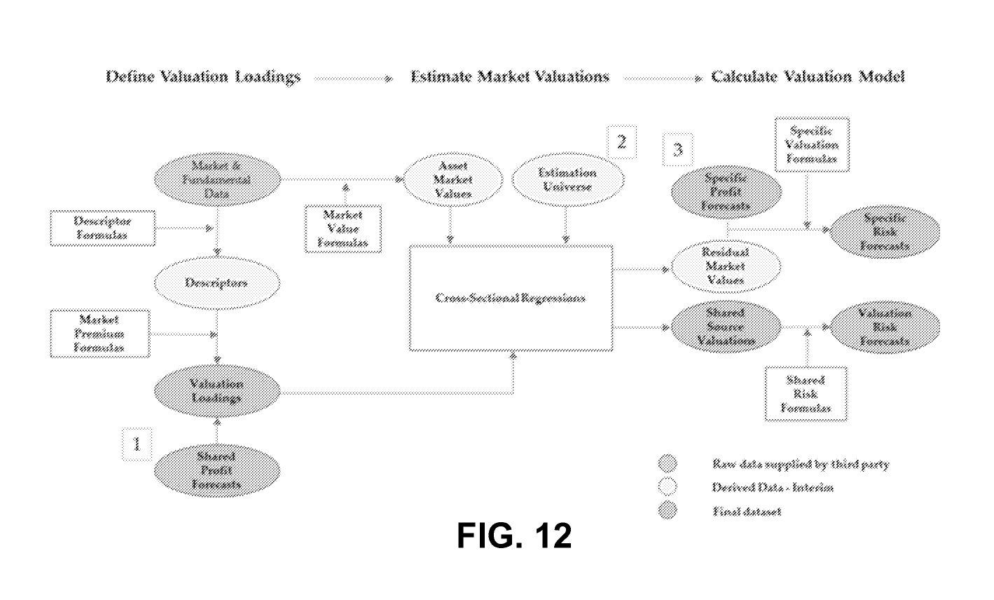

The system now follows the steps illustrated in FIG. 12 to apply transformations to the input data and the interim data—shared profit forecasts (1), the estimation universe (2), and the specific profit forecasts (3). Note the terms “source” and “factor” are used interchangeably.

In the next step, the system applies Market Value Formulas to compute Asset Market Values using Equation 6.

$$\frac{( Price * Shares ) - Adjustments}{NF} \qquad Equation 6$$

In this formula, Price is the share price of the security associated with the firm, Shares are the number of shares used to compute market value, Adjustments is the value to be removed to align market values with profits; and NF is the normalization factor to account for differences in firm size, if required. The adjustments and normalization factor are required to align the market values from the input datasets with the asset profit definitions and valuation loadings computed in the following step.

In the next step, the system applies Valuation Descriptor Formulas to calculate Valuation Descriptors known to explain market values but which do not significantly explain asset profits. For each selected factor, the system assigns descriptor values for each asset in the universe. Variants of the returns factor descriptors in Table 2 are potential candidates, with modifications as needed to account for the goal of explaining prices instead of changes in price (returns).

The next step is to apply Market Premium Formulas. In this step, the system applies the same mathematical transformations (multicollinearity, outlier, and standardization) used in the Profit Index Formulas step to the results from the Valuation Descriptor Formulas step and combines them with the shared profit forecasts to produce an n-by-m matrix of values referred to herein as Valuation Loadings.

In an alternative embodiment of the method, the system combines the Valuation and Profit descriptor steps and subsequently the associated index creation steps, then includes the Valuation Descriptors with the Profit Loadings in the profit regressions shown in FIG. 11. This alternative offers the simplification of steps at the expense of creating additional data (factors with insignificant profit levels) without interpretive value in the analysis steps, as well as potential infeasible solutions if profits for any factor are exactly zero.

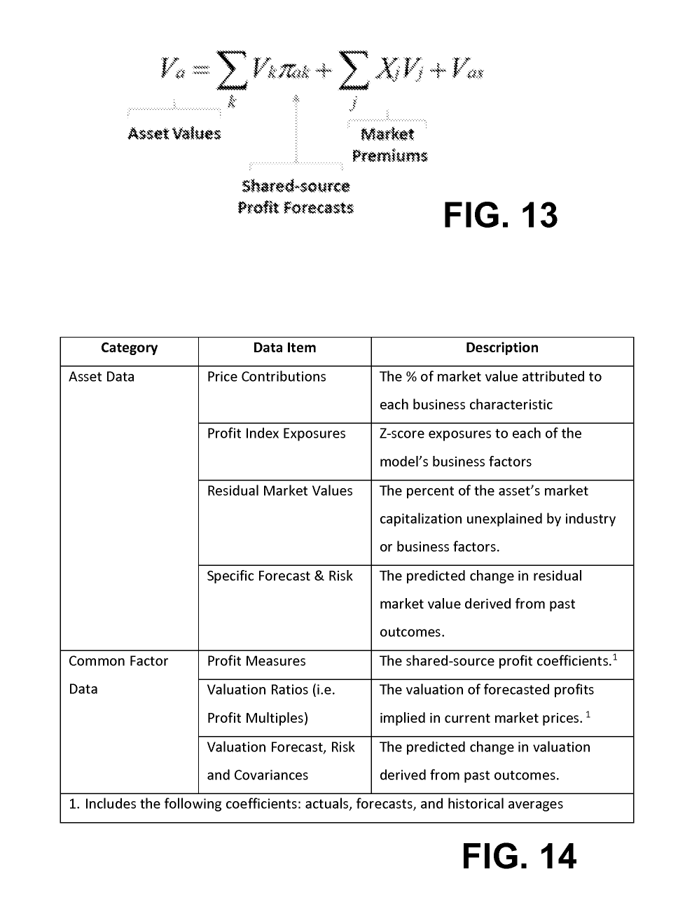

The next step is to apply Cross-sectional Weighted Regressions. In this step, the system's statistical software is invoked to apply a linear least-squares regression algorithm to the valuation loadings and asset market values to estimate the valuation coefficients as shown by the equation in FIG. 13.

In this formula, the asset values (Vₐ), profit forecasts (πₐₖ), and market premium exposures (Xⱼ)) are calculated in the preceding steps. The regression algorithm calculates the coefficients for each factor (Vₖ) and each market premium (Vⱼ) such that the residual market values for each asset (Vₐₛ) are as small as possible. The system uses the absolute value of profit forecasts such that the valuation coefficients are always positive if they explain positive marginal price. The system weights the regression to place more importance on firms with data known to be more reliable (e.g. for larger firms).

In an alternative embodiment of the method, the shared source profit forecasts are calculated with only the profit loadings, omitting the profit forecasts. The resulting factor coefficients from the valuation regressions are then divided by the corresponding factor profit forecasts to produce identical factor valuation coefficients, which has the advantage of efficiency if valuations with multiple profit forecast algorithms are employed. In either approach the residual market values produced by the statistical software are also identical.

While monthly estimations are likely sufficient for profit model steps, daily or even intraday estimations of valuations are required to reflect the latest market information.

In the next step, the system applies Shared Risk Formulas and Specific Valuation Formulas to the time series of Shared Source Valuations and Residual Market Values respectively to calculate valuation forecasts comprised of factor and firm-specific average valuation changes, volatility of said changes, and the correlation between variations of shared sources.

In the final step, the coefficients and residual market values calculated by the regression are used to calculate price contributions for each asset using Equation 8.

AFCₖ=(NF*Xₖ*VₖABS(πₖ))/MV Equation 8:

In this formula, AFC is the factor contribution to asset price for a given investment, k is the factor whose contribution is being calculated, NF is the normalization factor for the asset, Xk is the exposure of the asset to the factor, Vₖ is the factor valuation and πₖ is the profit measure for factor k.

The novel derived data calculated during the Model Calculation step and distributed to the analysis tools for use by the manager in the analysis steps is shown in FIG. 14.

### 7.2 First Embodiment for US Equities

The first embodiment of the method, which unless otherwise indicated was constructed using the best known mode, is a model comprised of the top 2,500 US equities with monthly estimation dates between January 1998 and March 2014.

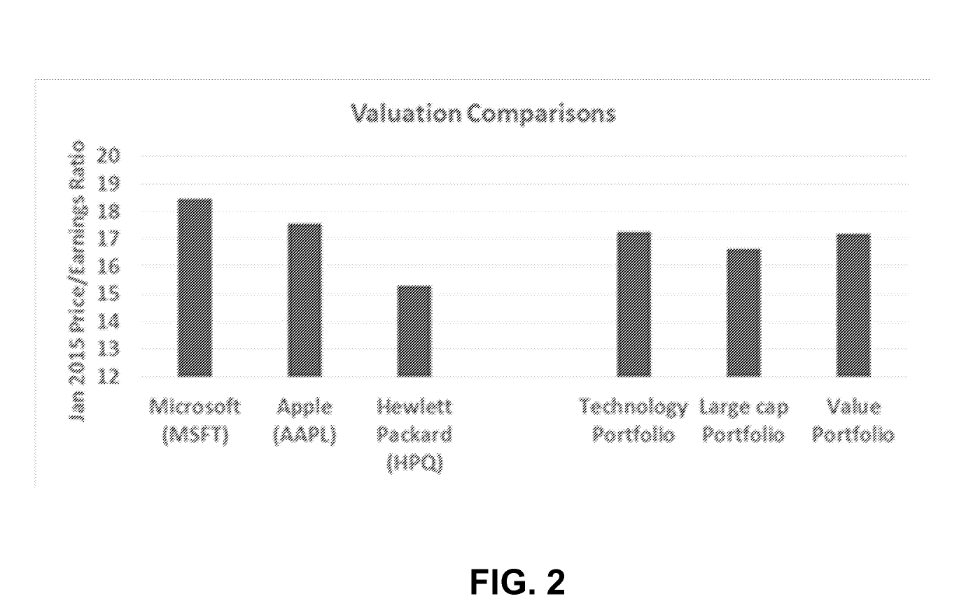

The embodiment's modeling system as shown in FIG. 2 is a set of databases hosted on the remotely accessed Linux-based portion of the system, accessed over the internet by statistical tools and database access tools hosted locally on a Windows-based system. The output data is packaged into Excel files and made available via FTP for managers to load into analysis tools.

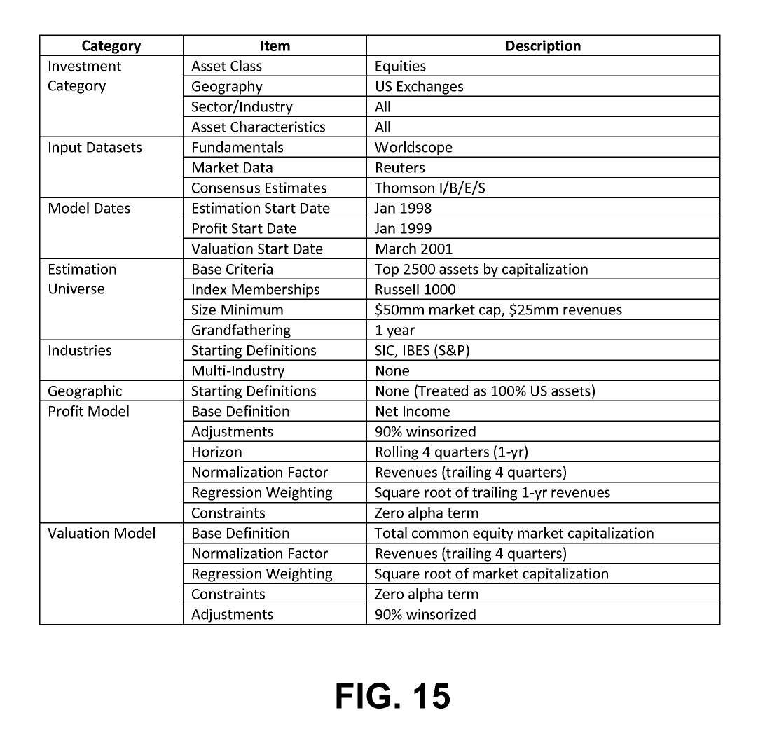

Asset Profits are defined as the sum of the firm's net income reported in the four quarters following the estimation date, with no adjustments for unusual items or for differences in reporting dates across firms. Asset Market Values are defined as the undiluted shares multiplied by market price. Both profits and market values are normalized for firm-size using the trailing four quarters of reported firm revenues and winsorized to remove the adverse effect of extreme outliers. FIG. 15 summarizes the parameters comprising the basic structure of the embodiment.

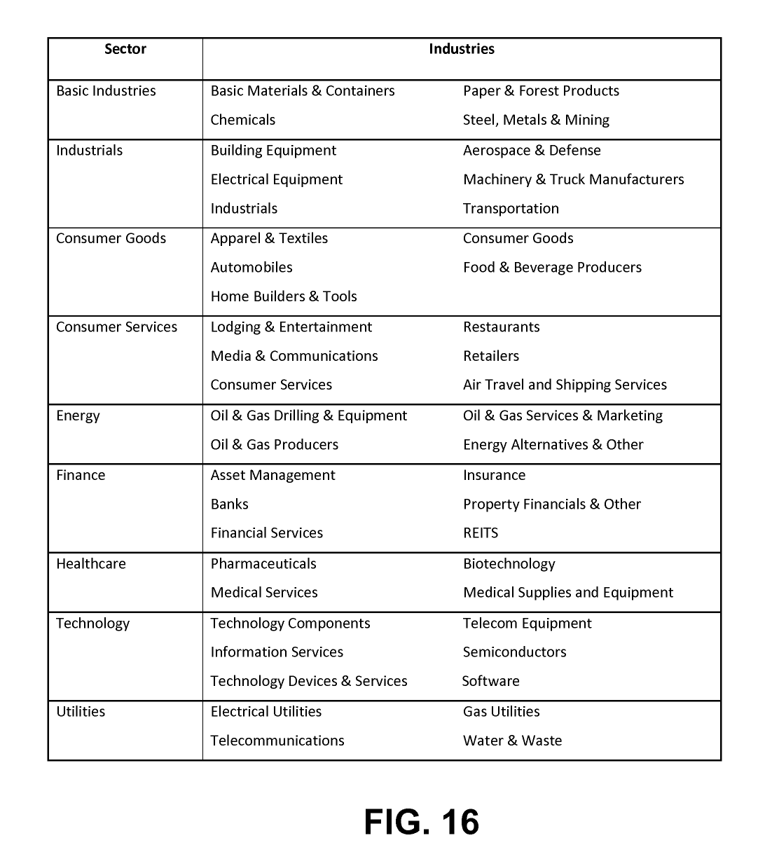

The embodiment includes forty-five industries as shown in FIG. 16. While geographic allocations might add value to distinguish between firms with global operations and those operating exclusively in the US, they are omitted to simplify the testing process.

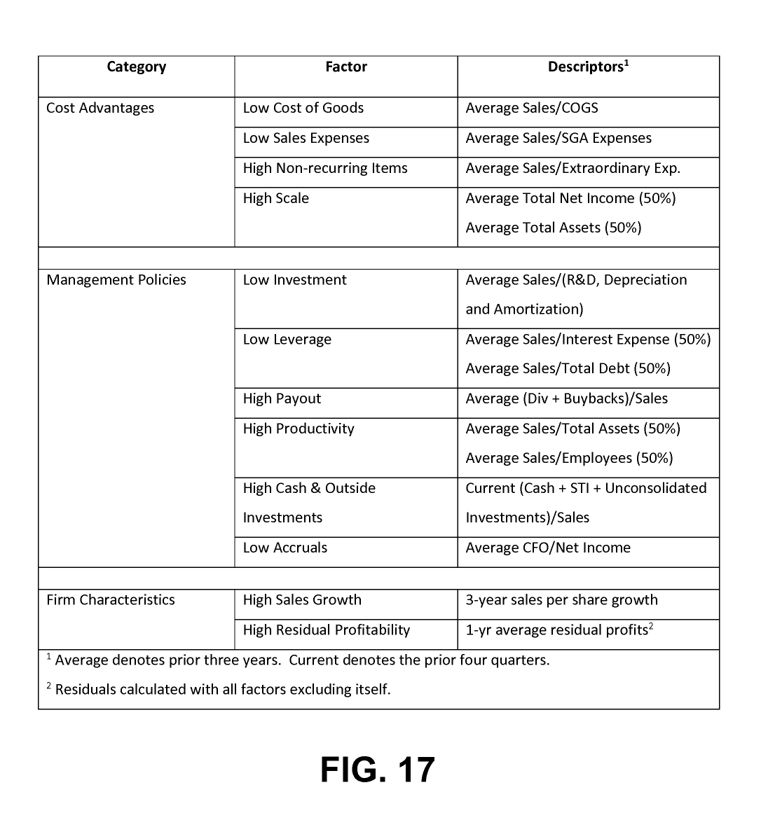

The embodiment includes twelve business factors as shown in FIG. 17. The selected factors are restricted to those based on reliable, broadly known information, primarily from reported financial statements. While some macroeconomic factors such as Global Price Sensitivity could possibly add value, they are omitted due to their reliance on time-series estimations and erratic interference with other factors.

The factors are structured such that industry sources capture average industry profitability and the business factors capture variations within industry. The exposures of factors with descriptors comprised of ratios to firm sales are normalized with respect to industry in addition to other transformations. Finally, the factors are structured as either “High” or “Low” such that more often than not an asset's positive exposure value to a factor explains positive incremental profits, and vice versa. Finally, the embodiment does not include any factors with price-based descriptors such as Value, Earnings Yield, Price Momentum, or Price Volatility commonly found in returns factor models.

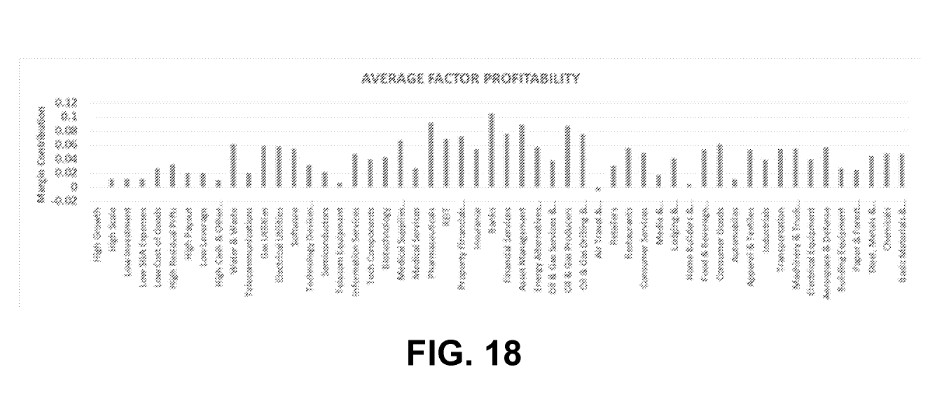

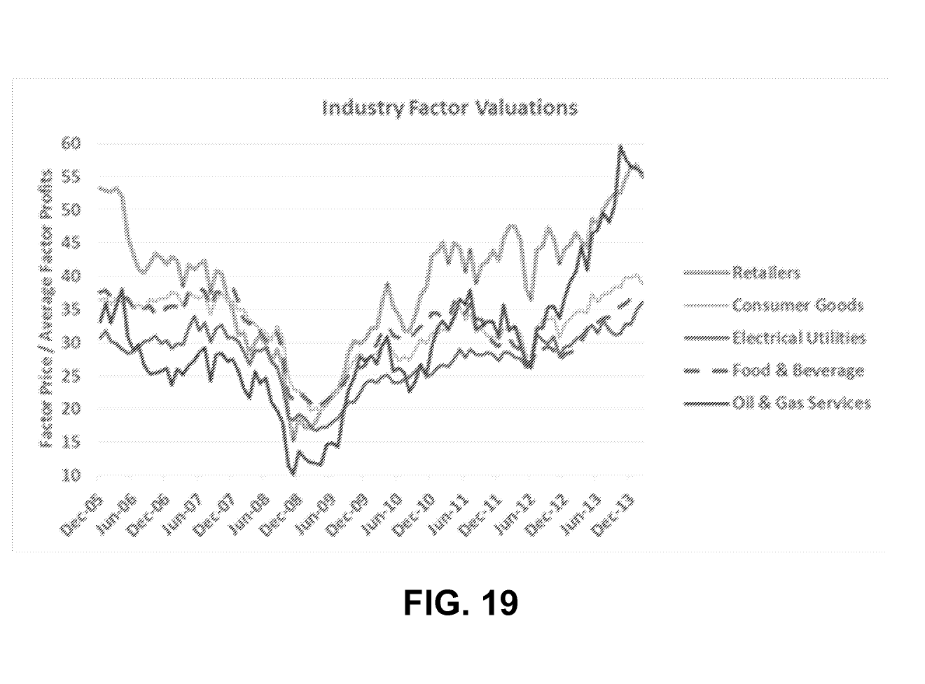

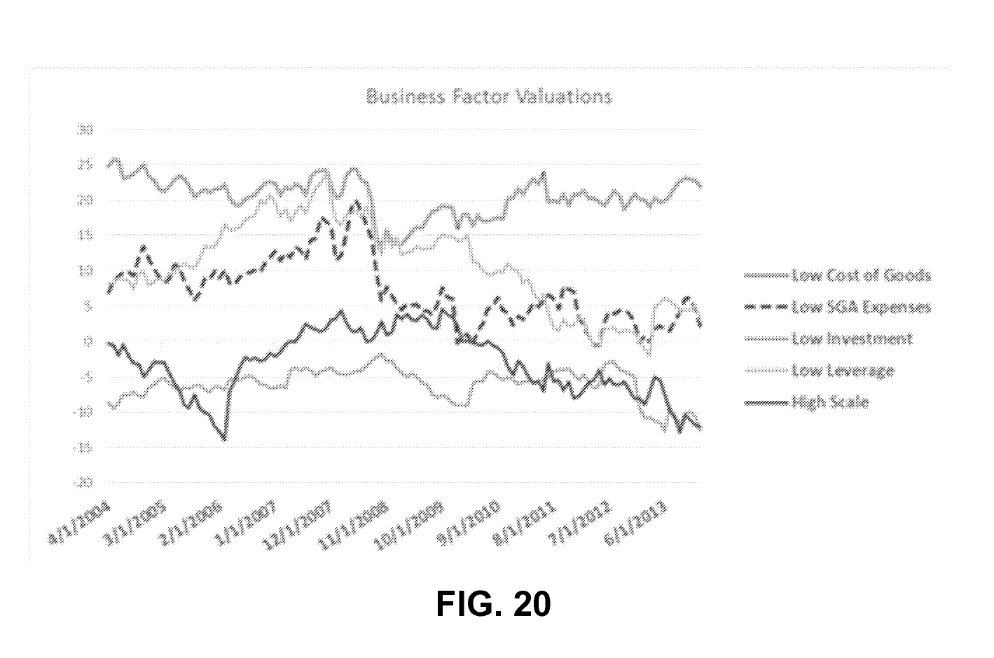

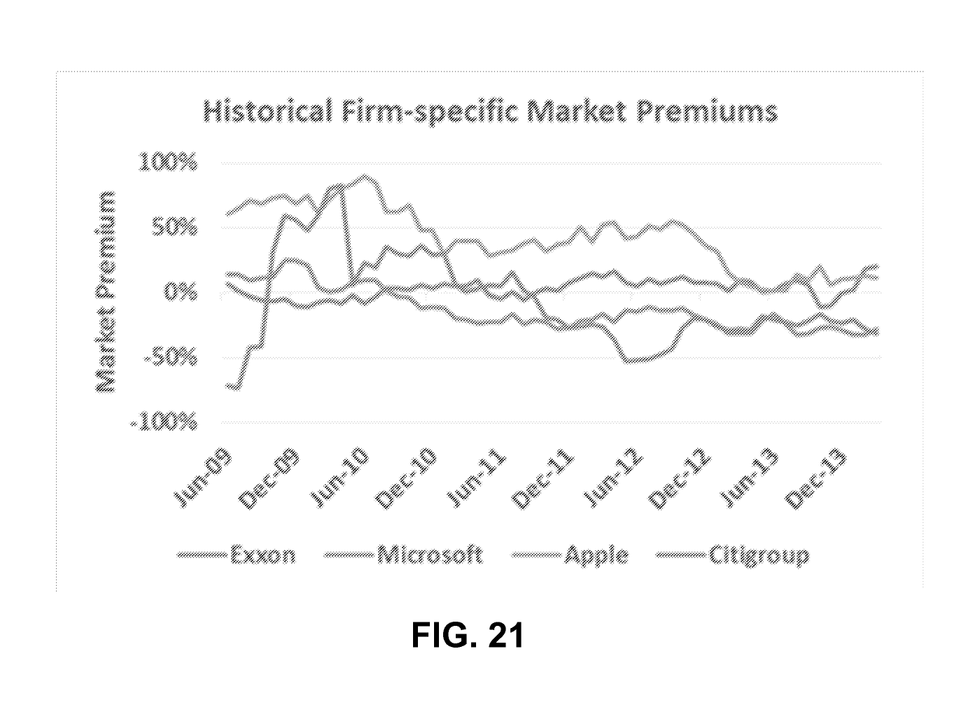

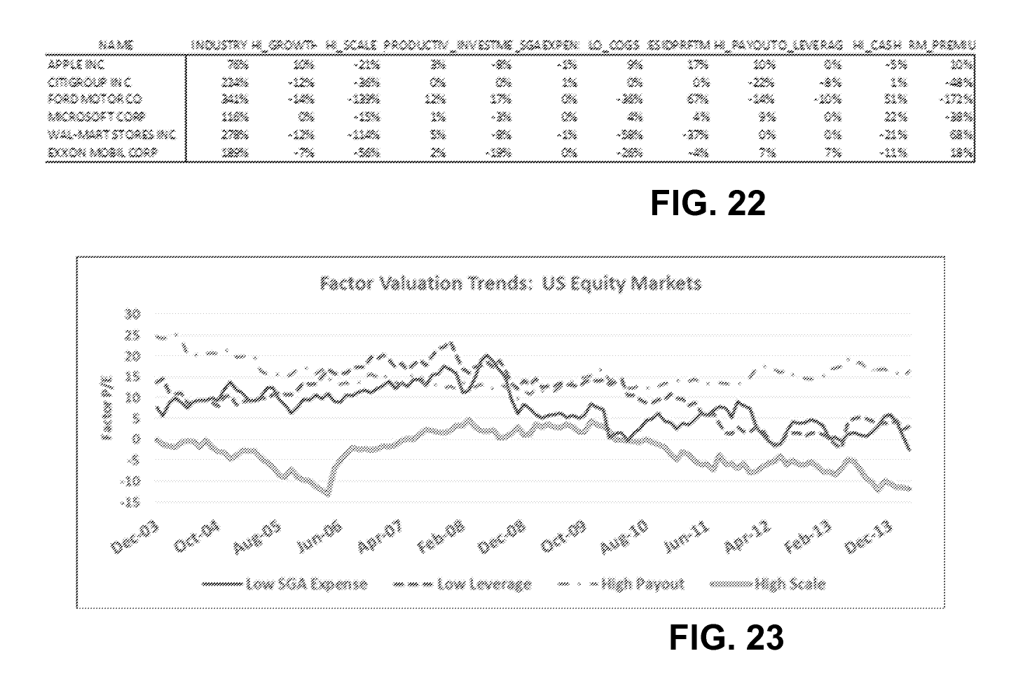

Selected output data from the first embodiment is shown in FIGS. 18-22. The first embodiment's average common profits for selected factors are shown in FIG. 18. The first embodiment's monthly valuations for selected industry factors from 2005-2014 are shown in FIG. 19. The first embodiment's monthly valuations for selected business factors from 2004-2014 are shown in FIG. 20. The first embodiment's historical firm-specific premiums for selected firms are shown in FIG. 21. The first embodiment's price contributions for selected firms are shown in FIG. 22.

### 7.3 the Process of Using the Invention

The precise steps followed to use the invention will vary depending on the manager's proprietary investment selection process, which reflects the skills, resources, and other available information available to the manager as well as the stated investment objectives and constraints communicated to external investors. However we are able to illustrate example steps to use the invention, which a manager can incorporate in whole or in part for the purpose of selecting investments. We group these examples into three series of steps: Stock Selection, Basket Selection, and Manager Selection.

A precursor in any series of steps is Factor Analysis. In this step, the manager evaluates the current valuations computed by the invention for each factor relative to the historical valuations of said factor and the current and historical valuations of alternative factors. The manager classifies each factor as either relatively cheap, relatively expensive, or relatively average.

FIG. 23 illustrates the Factor Analysis step with example data from the first embodiment for US equities. A manager reviewing this information in March 2014 might determine that High Scale, Low SGA Expenses, and Low Leverage are relatively cheap while High Payout is relatively expensive.

Stock Selection

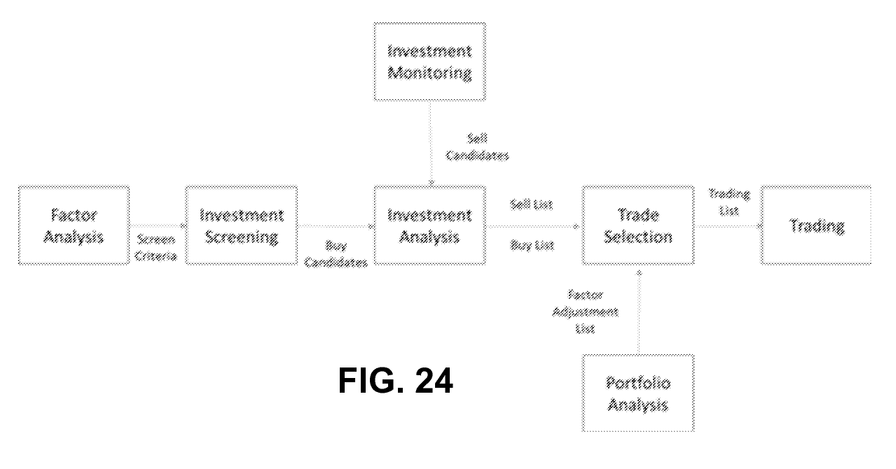

The Stock Selection steps are comprised of the Investment Screening, Investment Analysis, Portfolio Analysis, Investment Monitoring, and Trade Selection steps as illustrated in FIG. 24.

In the Investment Screening step, the manager defines rules based on the profit index exposure data calculated by the invention to filter the universe of investments into a subset with high values corresponding to factors deemed relatively cheap and low values corresponding to factors deemed relatively expensive. The manager may optionally specify additional rules to specify the maximum limit for the firm-specific premium of any investment. The manager adjusts the rules to raise or lower the limits until the subset of investments reaches the desired size.

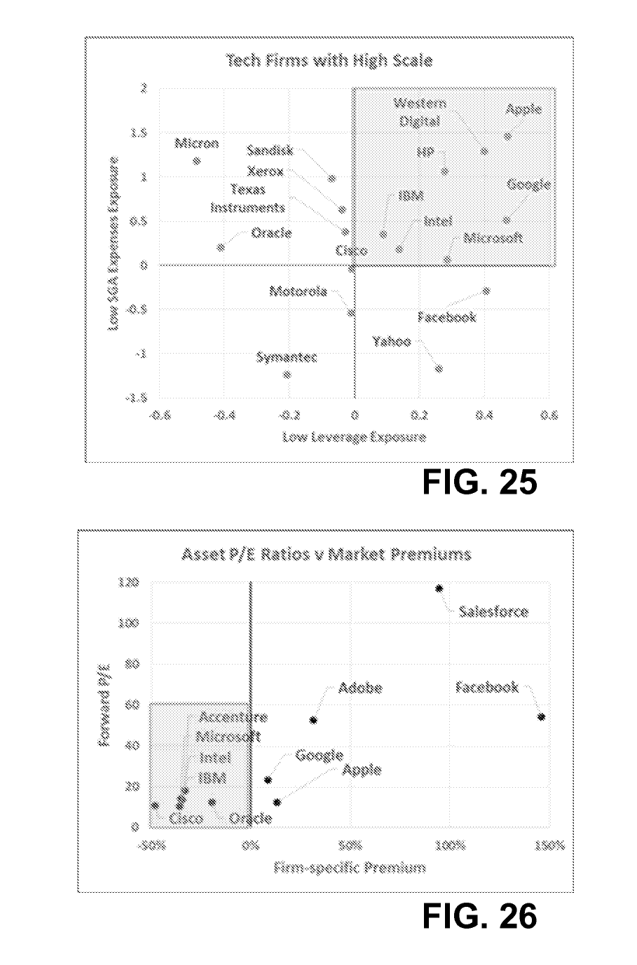

FIG. 25 illustrates the Investment Screening step with example results from a factor screen performed with the first embodiment for US equities to identify firms in the technology sector with exposure to High Scale above 3, exposure to Low Leverage above zero, and exposure to Low SGA Expenses above zero. A manager reviewing the results would determine that firms in the shaded section (Apple, Google, Microsoft, Intel, IBM, HP, and Western Digital) should be added to the list of buy candidates.

FIG. 26 illustrates the Investment Screening step with example results from a screen performed with the first embodiment for US equities to identify firms in the technology sector with negative firm-specific premiums. A manager reviewing the results would determine that the firms in the shaded section (Microsoft, Intel, IBM, Accenture, Cisco, Oracle) are viable candidates for analysis and adds them to the list of buy candidates. Relaxing the rule to premiums below 20% would add Google and Apple but not Adobe, Facebook, or Salesforce.com.

A related step is Investment Monitoring. In this step, the manager evaluates changes in attractiveness of each currently owned investment by monitoring changes to its firm-specific premium. If the firm-specific premium of a current investment rises above a threshold determined by the manager, the manager determines it may not be too expensive and adds it to the list of sell candidates.

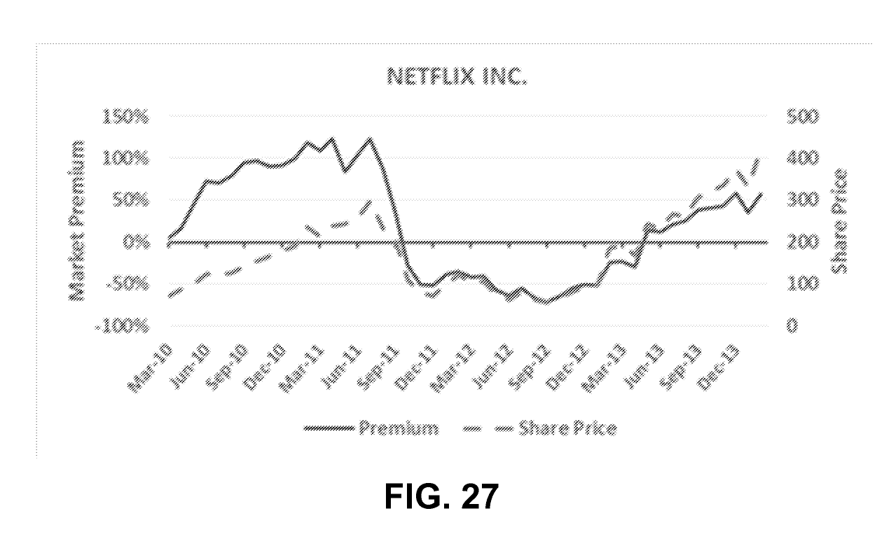

FIG. 27 illustrates the Investment Monitoring step with an analysis of the firm-specific premium for NetFlix Inc using the 1^{st} embodiment. In the example, a manager viewing the information in early 2014 might determine the investment is priced for higher firm-specific growth than when the investment was purchased (e.g. in mid-2012), reflecting a change in market sentiment that might exceed the manager's view. The manager determines to repeat the Investment Analysis steps to determine if the market view is justified or if the stock should be added to the list of sell candidates.

The next step is Investment Analysis. In this step, the manager performs the analysis unique to said manager's specific investment process (e.g. as described in the description of the DCF Method). The manager then determines the value of the expected exceptional firm-specific growth based on said analysis. The manager then compares the value from the analysis with the firm-specific premium calculated by the invention. If the analysis value is higher than the calculated value, the manager determines the investment is relatively cheap and adds the security to the buy list. If the analysis value is lower than the calculated value, the manager determines the investment is relatively expensive and adds the security to the sell list.

A related step is Portfolio Analysis. In this step, the manager evaluates the aggregate contributions to portfolio value (i.e. the value of investments currently owned) from each factor. In one possible embodiment, the manager calculates the multiplied product of portfolio weights (the percent of total portfolio market value derived from each asset in said portfolio) and the price contribution data calculated by the invention to determine the factor contributions. In an alternative embodiment the manager replaced portfolio weights with active weights relative to a benchmark portfolio. With either embodiment of the step the manager may optionally also calculate underlying exposures using z-scores or profitability averages. The manager then compares said aggregate contributions with the factor views developed in the Factor Analysis step. Small contributions from factors determined to be relatively cheap are determined to be too low and large contributions from factors determined to be relatively expensive are determined to be too high. The manager creates a factor adjustment list based on his determinations.

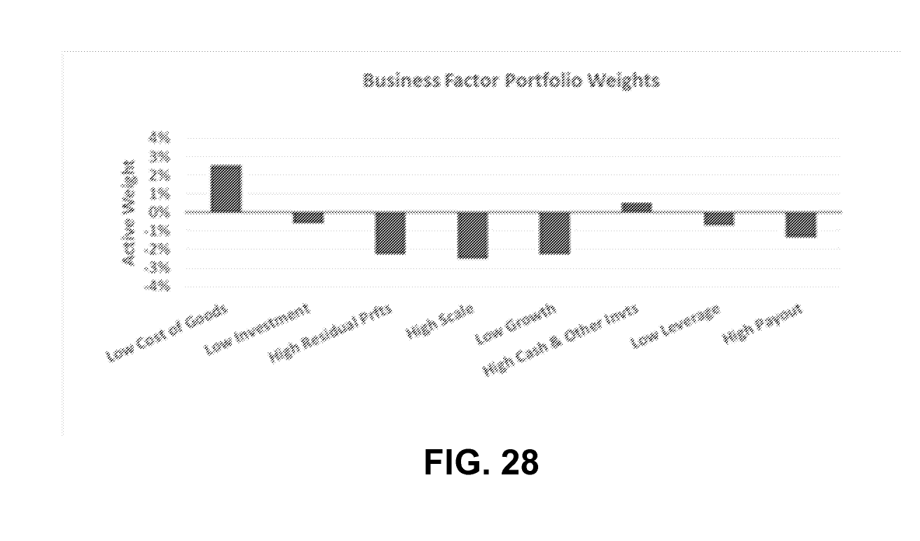

FIG. 28 illustrates the Portfolio Analysis step using portfolio information calculated with the first US embodiment. A manager reviewing this information would determine that Low Leverage, previously determined to be a cheap factor, is underweight and adds it to the factor adjustment list.

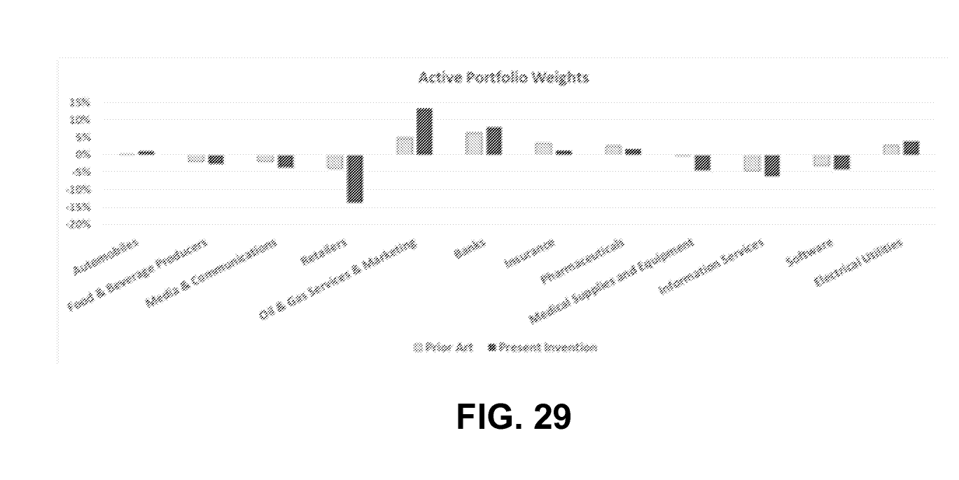

FIG. 29 illustrates the difference in portfolio industry weights between prior technology, which allocates the full dollar value of an investment to industry factors, and the present invention.

A step conducted after the Investment Analysis, Portfolio Analysis, and Investment Monitoring steps is Investment Selection. In this step, the manager uses the buy and sell lists produced by the Investment Analysis step, the factor adjustment lists from the Portfolio Analysis step, and/or the sell list produced by the Investment Monitoring step to produce a list of buy and sell orders to be executed by the trader.

Related to the Investment Selection step is the Investment Comparison step. In this step, the manager uses the datasets calculated by the invention to compare similar assets from the buy list to determine which is optimal for the portfolio.

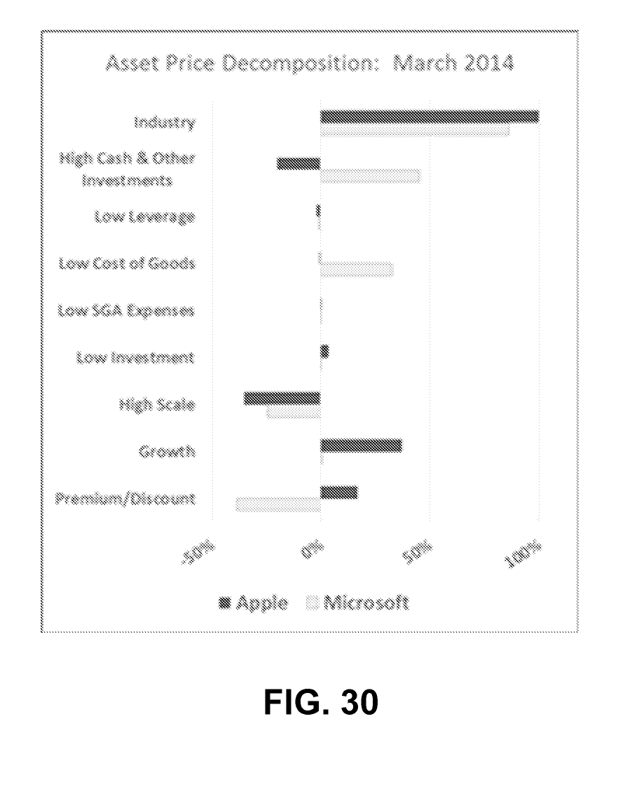

FIG. 30 illustrates the Investment Comparison step using data from the 1^{st} US embodiment. In this example, the manager compares Apple and Microsoft, both of which are discounted from High Scale but differ in other cost advantages, cash levels, and recent growth as well as in their firm-specific premiums.

Basket Selection

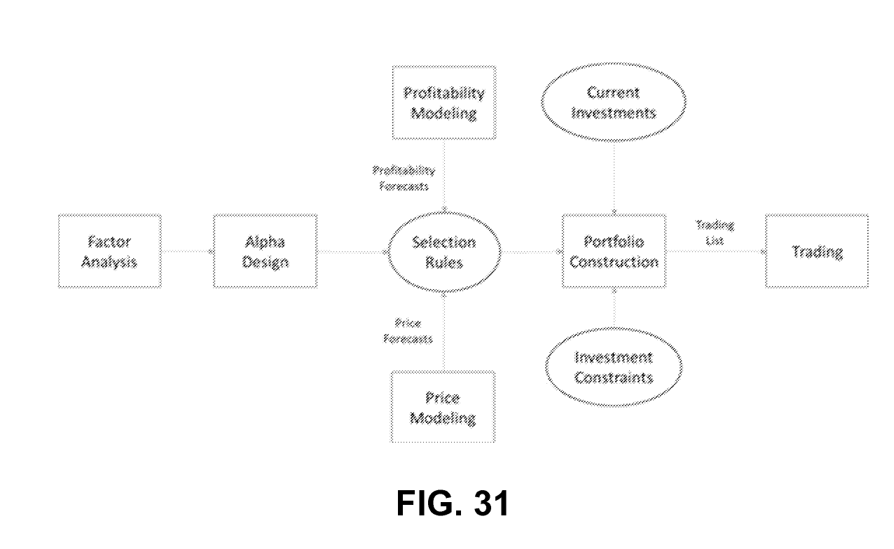

Managers who lack the resources to properly perform the Investment Analysis step for sufficient number of securities may alternatively follow the Basket Selection method, comprised of the Factor Analysis step, an Alpha Design step, an optional Profitability Modeling step, an optional Price Modeling step, a Portfolio Construction step, and a Trading step. These steps are illustrated in FIG. 31.

In the Alpha Design step, the manager uses the historical factor datasets and profit index exposure datasets calculated by the invention in conjunction with historical investment returns datasets within an analysis tool containing a rules-based software algorithm referred to as a backtester. In this step, the manager uses the factor information to define rules for purchasing and selling securities and then tests the rules using the historical datasets to determine if the rules would have resulted in above-average investment returns had they been applied in the past.

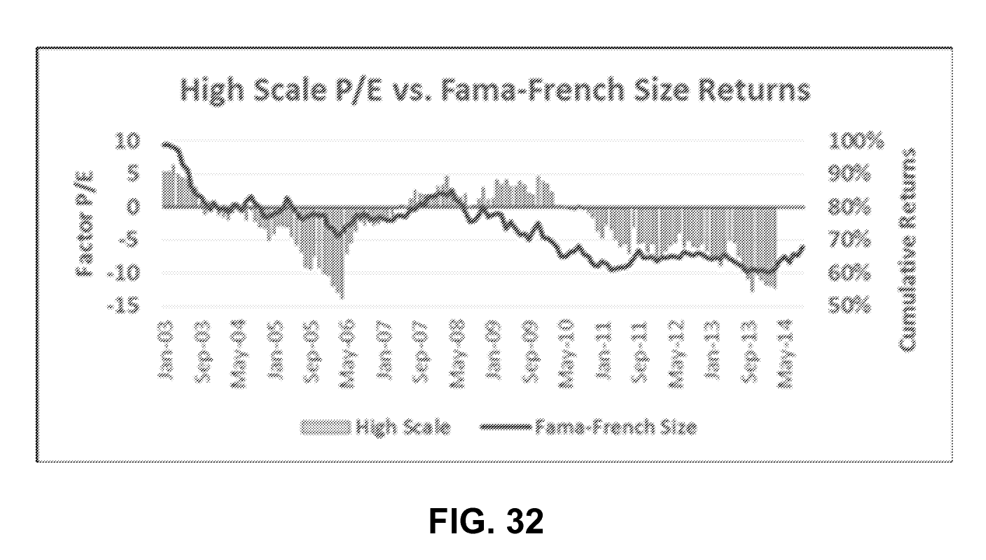

FIG. 32 illustrates the use of novel data from the present invention to define basket selection rules. By analyzing the data, the manager determines to sell investments in large firms and buy investments in small firms whenever High Scale valuations rise above 4. Conversely, the manager determines to sell investments in small firms and buy investments in large firms whenever High Scale valuations fall below −10. These rules are tested in conjunction with any other rules defined during the Alpha Design step.

In the optional Profitability Modeling step, the manager uses the historical factor datasets within a statistical analysis tool to calculate the predicted future profitability of factors and, by extension, each investment. Per asset data items calculated in this step include mean predicted total profitability, mean predicted firm-specific profitability, predicted total profit volatility, and predicted firm-specific profit volatility. Per factor data items calculated in this step include a mean predicted factor profitability and factor profit volatility. The predicted covariance between factor items is also calculated. The data is used to select investments with either higher expected profitability (defensive investments) or lower expected profitability (dynamic investments) the manager determines to be attractively priced.

In the optional Price Modeling step, the manager uses the Shared Risk and Specific Valuation Risk information in the novel datasets to calculate forecasts of investment prices and covariances of said forecasts, with the goal of improving returns through improved diversification of investment risk across common factors calculated by the invention.

In the Portfolio Construction step, the manager supplies the rules from the Alpha Design step, the portfolio of current investments, investment constraints and optionally the price and/or profitability models to the system's optimization algorithm to compute the portfolio basket of securities that best reflects all criteria and calculate the list of buy and sell orders to be executed by the trader.

Manager Selection

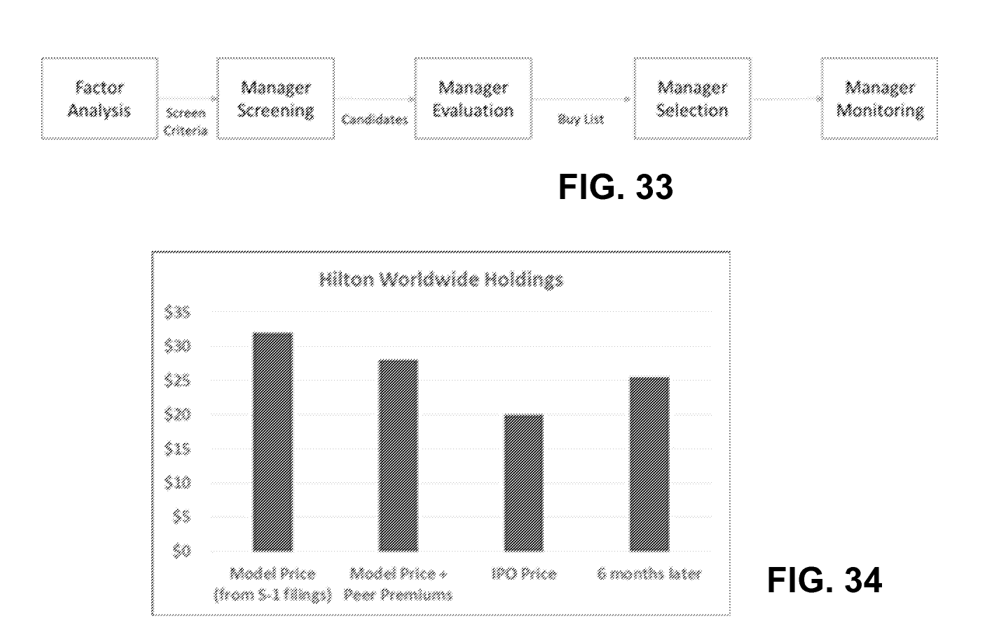

An alternative to Stock Selection and Basket Selection is Manager Selection. In this embodiment the manager uses an analysis system that includes 1) datasets calculated by the present invention and 2) current and historical holdings for a universe of portfolios managed by third-parties (e.g. mutual funds, separate accounts, or ETFs) according to disclosed parameters, to select a third-party manager with which to make an investment. Fund Selection is comprised of the Factor Analysis, Manager Screening, Manager Evaluation, Manager Selection, and Manager Monitoring steps as illustrated in FIG. 33.

In the Manager Screening step, the manager obtains a set of historical holdings from the universe of third-party manager candidates and adds the holdings to system's analysis tools. The manager compares the portfolio's historical aggregate factor price contributions with the third-party manager's stated investment objectives. Those determined to follow their stated strategy and whose stated strategy is determined to be attractive are added to the list of investment candidates.

In the Manager Evaluation step, the manager, in addition to other analysis conducted conforming to the manager's particular strategy, compares the aggregate factor price contributions of the investment candidates to those of other managed portfolios with whom the manager is currently invested to determine whether it is similar or different (diversifying).

In the Manager Selection step, the manager selects from the list of candidates the third-party manager that best conforms to the stated investment strategy and provides the diversification benefit desired by the manager. The investment strategy the manager agrees to follow in described in a policy statement using portfolio metrics calculated with the novel data from the present invention.

In the Manager Monitoring step, the manager loads period holdings from the third-party manager on an ongoing basis to determine if said third-party manager continues to follow the stated strategy.

Private Investment Selection

A distinct use of the invention is Private Investment Selection. In this step, the manager uses available financial statement data, for example the S-1 filings provided to the SEC for initial public offerings, to compute exposures to factors defined by the invention. The manager then uses the current factor profitability and valuation data computed by the invention to estimate a market value for the firm. The manager optionally computes an average firm-specific premium for comparable firms and adds it to the estimated value. Finally, the manager compares the estimated value with the purchase price offered by an investment banker. The manager purchases the private investment only if the estimated value exceeds the offered price.

FIG. 34 illustrates Private Investment Selection with an example from the 1^{st} US embodiment. The example compares the model-predicted, IPO, and subsequent market prices for Hilton Worldwide Holdings, which became public (again) in December 2013. The calculated model price based on data provided in the firm's S-1 filing is $32 and that value adjusted by the average discount of several comparable firms (Marriott, Starwood) is $28. Since both are significantly above the $20 IPO price offered by the investment banker, the manager determines the investment is attractive.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for predicting the contribution to the profits of each of a plurality of businesses from each of a plurality of common business characteristics comprising the steps of:
a. Supplying, for the plurality of said businesses, datasets of historical reported corporate profits and datasets of said historical business characteristics (factors) correlated to said corporate profits.
b. Calculating, for each of said factors and for each historical period in the dataset, a weighting value for each of said businesses representing the relationship between the business and the factor.
c. For each historical period in the dataset, applying a regression analysis to the plurality of weighting values for the plurality of factors and the reported profits for the plurality of businesses to determine the reported profits attributable to each of said factors.
d. Calculating a profit forecast for each of said factors comprised of 1) a weighted average of actual profits for said profit source, 2) the variation around the forecast, and 3) the covariance between said factor and all other factors.
e. For each of the plurality of businesses, calculating the profit forecast by scaling the profit forecasts of each of the plurality of factors by the weighting values of the business with respect to each of said factors.

2. A method for determining, for each of a plurality of historical periods, the market valuation of each of said plurality of factors and the unattributed market value of each of the plurality of businesses from claim 1 comprising the steps of:
a. Supplying, for the plurality of businesses, datasets of current and historical market values and historical profit forecasts of said businesses from each of said factors.
b. For the current period and also each historical period, applying a regression analysis to the plurality of business market values and business profit forecasts from the plurality of factors to determine 1) the valuation of said profits from each of said factors and 2) the unattributed market value for each of the plurality of businesses.

3. A method for making financial decisions comprising the steps of:
a. Supplying, for the plurality of said businesses, datasets of historical reported corporate profits and datasets of said historical business characteristics (factors) correlated to said corporate profits.
b. Calculating, for each of said factors and for each historical period in the dataset, a weighting value for each of said businesses representing the relationship between the business and the factor.
c. For each historical period in the dataset, applying a regression analysis to the plurality of weighting values for the plurality of factors and the reported profits for the plurality of businesses to determine the reported profits attributable to each of said factors.
d. Calculating a profit forecast for each of said factors comprised of 1) a weighted average of actual profits for said profit source, 2) the variation around the forecast and 3) the covariance between said factor and all other factors.
e. For each of the plurality of businesses, calculating the profit forecast by scaling the profit forecast of each of the plurality of factors by the weighting value of the business with respect to each of said factors.
f. Supplying, for the plurality of businesses, datasets of current and historical market values and historical profit forecasts of said businesses to each of said factors.
g. For the current period and also each historical period, applying a regression analysis to the plurality of business market values and business profit forecasts from the plurality of factors to determine 1) the valuation of said profits from each of said factors and 2) the unattributed market value for each of the plurality of businesses.

4. The method of claim 3 applied to determine whether to buy, sell, or hold a single security based on its current common profit weighting values the current and historical valuations of said profit factors and the unexplained current price of said security.

5. The method of claim 3 applied to determine whether to buy, sell, or hold a basket of securities wherein the method is based on the current weighting values to common profit factors of said securities and the current and historical valuations of a said factors, and the unexplained current price of said securities.

6. The method of claim 3 applied to determine whether to buy, sell, or hold an investment with a third-party manager based on the current and historical aggregate weighting values to common profit factors of said manager's portfolio of securities and the current and historical valuations of said profit factors.

7. The method of claim 3 applied to determine whether to purchase an IPO or other privately held investment based on the market value of said investment estimated using weighting values calculated with disclosed information about said investment.
